(19) United States
(12) Patent Application Publication
(10) Pub. No.: US 2017/0071138 A1
(43) Pub. Date: Mar. 16, 2017

(54) GARDEN STAKE FOR SECURING PLANTS

(71) Applicants: Stephen D. Cattie, Jenkintown, PA (US); Art J. Mattia, Elkins Park, PA (US)

(72) Inventors: Stephen D. Cattie, Jenkintown, PA (US); Art J. Mattia, Elkins Park, PA (US)

(21) Appl. No.: 15/259,794

(22) Filed: Sep. 8, 2016

Related U.S. Application Data
(60) Provisional application No. 62/217,139, filed on Sep. 11, 2015.

(51) Int. Cl. A01G 9/12

(52) U.S. Cl. CPC A01G 9/122; A01G 9/128

(57) ABSTRACT

A garden stake to secure vertically grown plants. The stake is configured to be driven deep into the ground via a machined point on the bottom end. A plurality of notches provide places to tie up the stem and branches as the plant grows throughout the growing season. An I-Beam cross section of the stake gives rigidity to the stake, preventing the stake from bending or breaking under the weight of the maturing plant.

### CROSS-REFERENCE TO RELATED APPLICATION

This application claims the benefit of priority of U.S. provisional application No. 62/217,139, filed Sep. 11, 2015.

### BACKGROUND OF THE GARDEN STAKE

The present invention relates to garden accessories and, more particularly, to stakes for vertically grown plants, such as saplings, vegetable plants, such as tomatoes, beans, and other vegetables.

For vertically grown plants, it is customary to tie the plants off to a stake to support the plant as it grows through a growing season, or a portion of the plant's life cycle. Conventional Tomato and vegetable stakes tend to bend or break from the weight of the vegetables, particularly at later stages, when they ripen.

Another deficiency with current growing stakes is that the ties used to secure the plant to the stake tend to slide down the pole, thereby failing to keep the vegetables off the ground, where they are more susceptible to insects, rodents, spoilage or premature rotting due to contact with the ground.

As can be seen, there is a need for an improved garden stake that permits securement of a vertically grown plant during its growing cycle.

### SUMMARY OF THE GARDEN STAKE

In one aspect of the present invention, a garden stake for securing a growing plant includes an elongate stake body, having a plurality of notches defined in a side surface of the stake body in spaced apart relation along a longitudinal length of thereof. The garden stake includes a ground penetrating point defined at a lower end of the elongate body and a striking head formed at an upper end of the elongate body.

The elongate body of the garden stake may have a substantially cross shaped cross section along the longitudinal length of the stake body below the striking head. The substantially cross shaped cross section may be formed such that a raised portion of the elongate body has a channel formed between the raised portion and an adjacent raised portion. The notches may be formed in the raised portion such that the notches have an upwardly oriented opening forming a retaining hook. The notches may be formed in pairs on opposite sides of the elongate body. In a preferred embodiment, the pairs of notches are defined along the raised portions alternately between a first pair of opposed raised portions and a second pair of opposed raised portions.

These and other features, aspects and advantages of the present invention will become better understood with reference to the following drawings, description and claims.

### BRIEF DESCRIPTION OF THE DRAWINGS

FIG. 1 is a perspective view of a garden stake, shown in use;

FIG. 2 is a perspective view of the garden stake;

FIG. 3 is a detail perspective view of the garden stake;

FIG. 4 is a section view of the garden stake, taken along line 4-4 in FIG. 3;

FIG. 5 is a section view of the garden stake, taken along line 5-5 in FIG. 3;

FIG. 6 is a section view of the garden stake, taken along line 6-6 in FIG. 4;

FIG. 7 is a detail section view of the garden stake; and

FIG. 8 is a section view of the garden stake, taken along line 8-8 in FIG. 1, illustrating the stake after begin driven into ground 20.

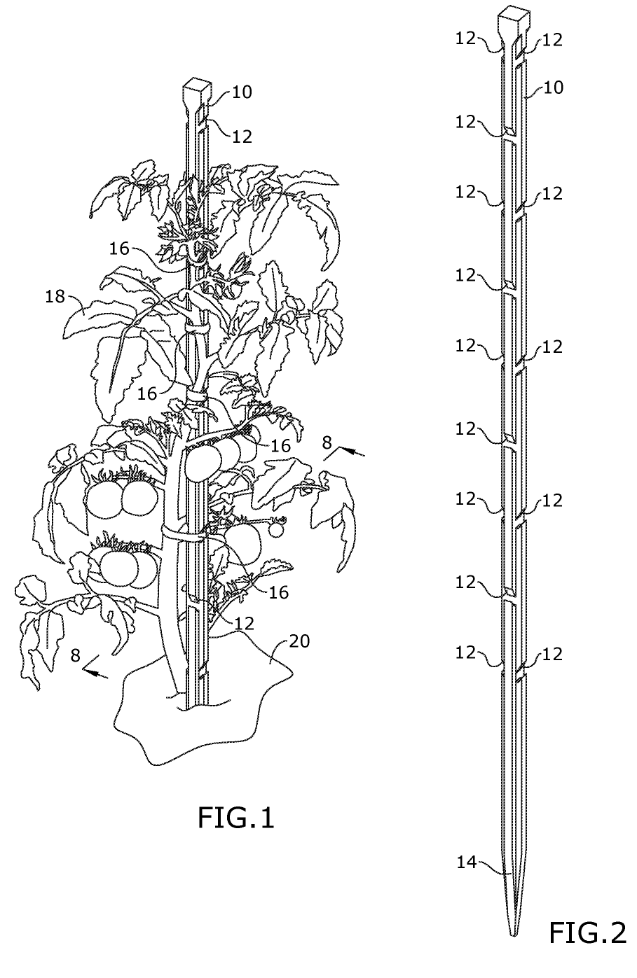

### DETAILED DESCRIPTION OF THE GARDEN STAKE

The following detailed description is of the best currently contemplated modes of carrying out exemplary embodiments of the garden stake. The description is not to be taken in a limiting sense, but is made merely for the purpose of illustrating the general principles of the garden stake, since the scope of the garden stake is best defined by the appended claims.

Broadly, an embodiment of the present invention provides an improved garden stake for securing vertically grown plants and vegetables.

As seen in reference to the several views of the drawings, an improved plant stake according to the present invention includes an elongate stake body 10. The body has a plurality of notches 12 defined in a side surface of the body in spaced apart relation along a longitudinal length of the stake body 10. A lower end of the elongate body 10 has a ground penetrating stake point 14 defined at an end portion of the stake body 10. An upper end of the stake 10 has a striking head 15 so that the stake 10 may be driven into the ground 20 by the ground penetrating point 14. The stake may be formed of wood, high strength plastics, composites, or metal.

In use, the stake point 14 is driven into the surface of the ground 20. As the plant 18 grows, a gardener tending the plant may apply a plurality of ties 16 to tie a stem 22 of the growing plant 18 to the stake 10. Preferably, a portion of the tie 16 is received within the notches 12 to prevent the ties 16, and thereby, the plant 18 from sliding downwardly on the stake as the plant matures and begins to bear fruit.

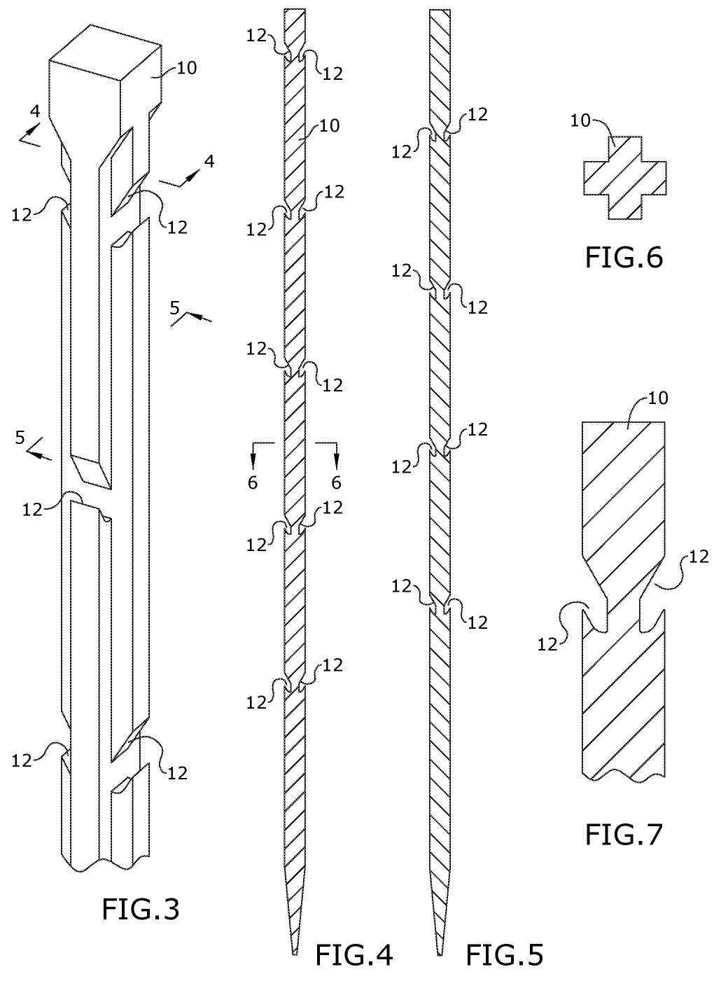

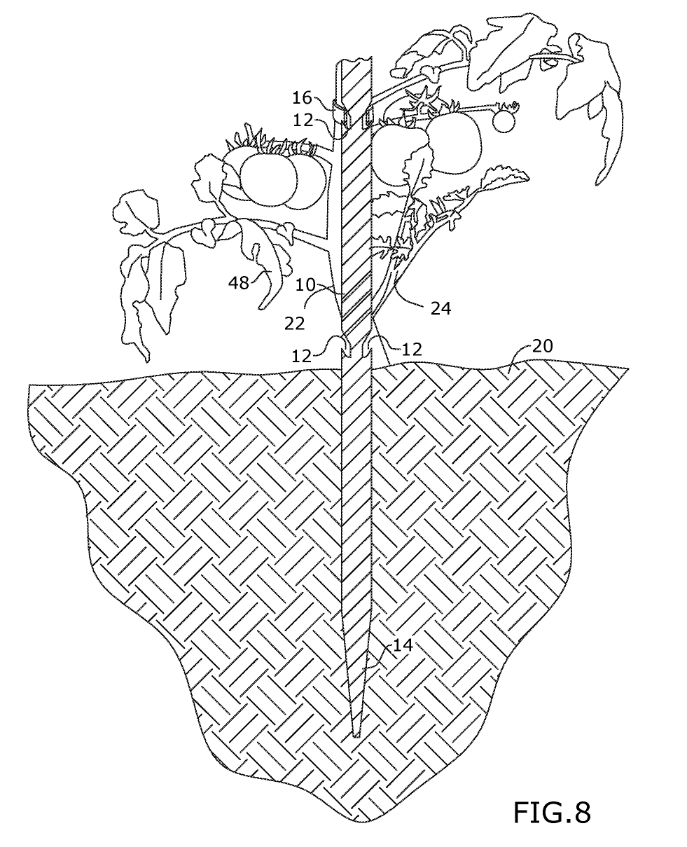

As seen in reference to FIGS. 3 and 6, the elongate stake body 10 is formed with a substantially cross shaped cross section, such that a raised portion has a channel formed between it and an adjacent raised portion.

As further seen in reference to FIGS. 3 -7, the notches 12 are defined in the raised portion, such that the notches 12 have an upwardly oriented opening forming a retaining hook. In a preferred embodiment, the notches 12 are defined along the raised portions alternately between a first pair of opposed raised portions and a second pair of opposed raised portions.

The upwardly oriented openings of the notches 12 are optimally configured for retaining the tie 16 in the hooked opening to prevent downward slippage of the tie 16 and thereby the plant as the plant matures. For plants 18 that exhibit continued growth along its main stem 22, the ties 16 may slide upwardly along the stake 10 as the plant grows to prevent the growing stem from binding and deforming at a fixed tie or having a laterally extending branch stem 24 from being damaged or stripped off by the tie 16 if it were maintained in a fixed position along the stake 10. The gardener may then reposition the tie to a new notch 12 at a higher elevation in an elevated condition relative to the ground.

It should be understood, of course, that the foregoing relates to exemplary embodiments of the garden stake and that modifications may be made without departing from the spirit and scope of the garden stake as set forth in the following claims.

What is claimed is:

1. A garden stake for securing a growing plant, comprising:
an elongate stake body, having a plurality of notches defined in a side surface of the stake body in spaced apart relation along a longitudinal length of thereof;
a ground penetrating point 14 defined at a lower end of the elongate body; and
a striking head formed at an upper end of the elongate body.

2. The garden stake of claim 1, wherein the elongate stake body has a substantially cross shaped cross section along the longitudinal length of the stake body below the striking head.

3. The garden stake of claim 2, wherein the substantially cross shaped cross section is formed such that a raised portion of the elongate body has a channel formed between the raised portion and an adjacent raised portion.

4. The garden stake of claim 3, wherein the notches are formed in the raised portion such that the notches have an upwardly oriented opening forming a retaining hook.

5. The garden stake of claim 4, wherein the notches are formed in pairs on opposite sides of the elongate body.

6. The garden stake of claim 5, wherein the pairs of notches are defined along the raised portions alternately between a first pair of opposed raised portions and a second pair of opposed raised portions.
